(19) United States
(12) Patent Application Publication
(10) Pub. No.: US 2004/0051290 A1
(43) Pub. Date: Mar. 18, 2004

(54) Hauling system

(76) Inventor: W. Bruce Morgan, Phoenix, AZ (US)

Correspondence Address: STONEMAN LAW OFFICES, LTD, 3113 NORTH 3RD STREET, PHOENIX, AZ, 85012, US

(21) Appl. No.: 10/655,084

(22) Filed: Sep. 3, 2003

Related U.S. Application Data
(60) Provisional application No. 60/408,489, filed on Sep. 4, 2002.

(51) Int. Cl. B60R 3/00

(52) U.S. Cl. 280/769

(57) ABSTRACT

A hauling system for improved transportation of a motorized personal vehicle such as a motorized cart most often used by persons who have a difficult time walking. The hauling system provides a gravity-tilting platform attached to a trailer hitch that allows a single user to load and transport the motorized cart. The user can actuate the cart and drive it up onto, or off of, the platform. When the cart is driven off of the platform it tilts to the ground and provides a ramp. When the cart is driven onto the platform it tilts off the ground to a lockable horizontal position for transport.

### CROSS-REFERENCE TO RELATED APPLICATION

The present application is related to my prior provisional application Serial No. 60/408,489, filed Sep. 4, 2002, entitled “HAULING SYSTEM”, from which I claim priority, the contents of which are incorporated herein by this reference and is not admitted to be prior art with respect to the present invention by the mention in this cross-reference section.

### BACKGROUND

This invention relates to providing a hauling system for improved transportation of a motorized personal vehicle (herein referred to as a motorized cart or just a cart). Mobility-challenged individuals most often use such motorized carts. This invention provides an apparatus and method to load and transport such motorized carts in combination with a transport vehicle, such as a car, truck or van.

Generally, persons using a motorized cart have a need to transport their motorized cart from location to location. Most typically, a hydraulic lift/platform is attached to a transport vehicle and used to move the three or four-wheeled cart from the ground onto a lifting platform, where such platform is raised for transport. Such platforms may be attached to the rear of a transport vehicle or set onto the bed of a truck used for transport. Other methods of transport include placing the motorized cart onto a two or four-wheeled trailer and connecting the trailer to a trailer hitch on the rear of a transport vehicle. These types of cart lifts require lifting the cart onto the trailer, or complicated maneuvering that is difficult for one person.

### OBJECTS OF THE INVENTION

A primary object and feature of the present invention is to provide a hauling system, comprising a hauler, attachable to a transport vehicle, for hauling a motorized cart.

It is a further object and feature of the present invention to provide such a system that is gravitationally tilted such that the motorized cart may be driven onto, and off of, the hauler by a single user without manual lifting of the motorized cart.

It is a further object and feature of the present invention to provide such a system that provides a wheel guiding system for positioning the motorized cart on the hauler.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a hauling system attachable to at least one transport vehicle, for hauling at least one motorized cart of the type that is drivable, comprising, in combination: a hauler comprising, first attachment means for attaching such hauler to the at least one transport vehicle; second attachment means for attaching the at least one motorized cart to such hauler; at least one support means for supporting the at least one motorized cart; tilting means for tilting such at least one support means in at least one first direction such that the at least one motorized cart may be driven onto such at least one support means; and tilting such at least one support means in at least one second direction when the at least one motorized cart is driven substantially onto such at least one support means; at least one first blocking means for blocking such at least one support means in a substantially horizontal position; and at least one second blocking means for blocking the at least one motorized cart when the at least one motorized cart is supported by such at least one support means and such at least one support means is in such substantially horizontal position; wherein the at least one motorized cart is substantially supported by the at least one transport vehicle when such hauler is attached to the at least one transport vehicle and in such substantially horizontal position. Moreover, it provides such a hauling system further comprising at least one wheel guiding means, attached to such at least one support means, for guiding at least one wheel of the motorized cart onto such hauler.

In accordance with another preferred embodiment hereof, this invention provides a hauling system attachable to at least one transport vehicle, for hauling at least one motorized cart of the type that is drivable, comprising, in combination: a hauler comprising, at least one first attacher structured and arranged to attach such hauler to the at least one transport vehicle; at least one second attacher structured and arranged to attach the at least one motorized cart to such hauler; at least one supporter structured and arranged to support the at least one motorized cart; at least one tilter, structured and arranged to tilt such at least one supporter in at least one first direction such that the at least one motorized cart may be driven onto such at least one supporter; and structured and arranged to tilt such at least one supporter in at least one second direction when the at least one motorized cart is driven substantially onto such at least one supporter; at least one first blocker structured and arranged to block such at least one supporter in a substantially horizontal position; and at least one second blocker structured and arranged to block the at least one motorized cart when the at least one motorized cart is supported by such at least one supporter and such at least one supporter is in such substantially horizontal position; wherein the at least one motorized cart is substantially supported by the at least one transport vehicle when such hauler is attached to the at least one transport vehicle and in such substantially horizontal position.

Additionally, it provides such a hauling system further comprising at least one wheel guider, attached to such at least one supporter, structured and arranged to guide at least one wheel of the motorized cart onto such hauler. Also, it provides such a hauling system wherein such at least one first attacher comprises: at least one hitch receiver, attachable to the at least one transport vehicle; and at least one hitch mating-member, attachable to such hauler; wherein such at least one hitch mating-member will mate with such at least one hitch receiver such that when such at least one hitch receiver is attached to the at least one transport vehicle such hauler is substantially supported by the at least one transport vehicle.

In addition, it provides such a hauling system wherein such at least one first attacher comprises: at least one hitch receiver, attachable to the at least one transport vehicle; and at least one hitch mating-member, attachable to such hauler; wherein such at least one hitch mating-member will mate with such at least one hitch receiver such that when such at least one hitch receiver is attached to the at least one transport vehicle such hauler is substantially supported by the at least one transport vehicle. And, it provides such a hauling system wherein such at least one second attacher comprises: at least two tie-down connectors; at least one tie-down strap having two ends and being structured and arranged to be tightened, each respective such end being structured and arranged to removably attach to at least one of such at least two tie-down connectors; wherein each respective such end is attached to at least one of such at least two tie-down connectors and tightened over the motorized cart such that the motorized cart is firmly held to such hauler by such at least one tie-down strap and such at least two tie-down connectors.

Further, it provides such a hauling system wherein such at least one second attacher comprises: at least two tie-down connectors; at least one tie-down strap having two ends and being structured and arranged to be tightened, each respective such end being structured and arranged to removably attach to at least one of such at least two tie-down connectors; wherein each respective such end is attached to at least one of such at least two tie-down connectors and tightened over the motorized cart such that the motorized cart is firmly held to such hauler by such at least one tie-down strap and such at least two tie-down connectors.

Even further, it provides such a hauling system wherein such at least one supporter comprises at least one platform and at least one structural frame. Moreover, it provides such a hauling system wherein such platform is substantially planar and comprises a mesh floor. Additionally, it provides such a hauling system wherein such platform comprises at least one end, which is flush with such mesh floor. Also, it provides such a hauling system wherein such at least one supporter comprises at least one platform and at least one structural frame.

In addition, it provides such a hauling system wherein such at least one tilter comprises: at least one hollow outer cylinder; and at least one inner cylinder; wherein such at least one inner cylinder supports the at least one hollow outer cylinder; wherein such at least one inner cylinder is substantially within such at least one hollow outer cylinder; and wherein such at least one outer cylinder freely rotates around such at least one inner cylinder in both a clockwise and counterclockwise direction.

And, it provides such a hauling system wherein such at least one tilter comprises: at least one hollow outer cylinder; and at least one inner cylinder; wherein such at least one inner cylinder supports the at least one hollow outer cylinder; wherein such at least one inner cylinder is substantially within such at least one hollow outer cylinder; and wherein such at least one outer cylinder freely rotates around such at least one inner cylinder in both a clockwise and counter-clockwise direction. Further, it provides such a hauling system further comprising at least one wheel guider, attached to such at least one supporter, structured and arranged to guide at least one wheel of the motorized cart onto such hauler.

In accordance with another preferred embodiment hereof, this invention provides a hauling system, comprising, in combination: at least one transport vehicle; at least one motorized cart; at least one hauler comprising at least one first attacher structured and arranged to attach such hauler to such at least one transport vehicle; at least one second attacher structured and arranged to attach such at least one motorized cart to such hauler; at least one supporter structured and arranged to support such at least one motorized cart; at least one tilter, structured and arranged to tilt such at least one supporter in at least one first direction such that such at least one motorized cart may be driven onto such at least one supporter; and structured and arranged to tilt such at least one supporter in at least one second direction when such at least one motorized cart is driven substantially onto such at least one supporter; at least one first blocker structured and arranged to block such at least one supporter in a substantially horizontal position; and at least one second blocker structured and arranged to block such at least one motorized cart when such at least one motorized cart is supported by such at least one supporter and such at least one supporter is in such substantially horizontal position; wherein such at least one motorized cart is substantially supported by such at least one transport vehicle when such hauler is attached to such at least one transport vehicle and in such substantially horizontal position.

Even further, it provides such a hauling system further comprising at least one wheel guider, attached to such at least one supporter, structured and arranged to guide at least one wheel of such motorized cart onto such at least one hauler. Even further, it provides such a hauling system wherein such at least one tilter comprises: at least one hollow outer cylinder; and at least one inner cylinder; wherein such at least one inner cylinder supports the at least one hollow outer cylinder; wherein such at least one inner cylinder is substantially within such at least one hollow outer cylinder; and wherein such at least one outer cylinder freely rotates around such at least one inner cylinder in both a clockwise and counter-clockwise direction.

Even further, it provides such a hauling system wherein such at least one first attacher comprises: at least one hitch receiver, attachable to the at least one transport vehicle; and at least one hitch mating-member, attachable to such hauler; wherein such at least one hitch mating-member will mate with such at least one hitch receiver such that when such at least one hitch receiver is attached to the at least one transport vehicle such hauler is substantially supported by the at least one transport vehicle.

Furthermore, it provides such a hauling system wherein such at least one second attacher comprises: at least two tie-down connectors; at least one tie-down strap having two ends and being structured and arranged to be tightened, each respective such end being structured and arranged to removably attach to at least one of such at least two tie-down connectors; wherein each respective such end is attached to at least one of such at least two tie-down connectors and tightened over the motorized cart such that the motorized cart is firmly held to such hauler by such at least one tie-down strap and such at least two tie-down connectors.

### BRIEF DESCRIPTION OF THE DRAWINGS

FIG. 1 is a perspective view of a hauler of the hauling system attached to a transport vehicle, according to a preferred embodiment of the present invention.

FIG. 2 is an illustrated top view of the hauler of FIG. 1.

FIG. 3 is a side view, through section 3-3 of FIG. 4.

FIG. 4 is an illustrated front view of the hauler of FIG. 2, according to a preferred embodiment of the present invention.

FIG. 5 is an illustrated front view of the hauler of FIG. 2 in a loading position, attached to the rear of a transport vehicle, according to a preferred embodiment of the present invention.

FIG. 6 is an illustrated front view of the hauler of FIG. 2 in a transport position, attached to the rear of a transport vehicle, according to a preferred embodiment of the present invention.

FIG. 7 is a perspective view, partially in section, of Detail 7 of FIG. 2.

FIG. 8 is a top view, partially in section, of a portion of the hauler platform illustrating a wheel holder for a four-wheel cart of the hauling system, according to another embodiment of the present invention.

FIG. 9 is a perspective view, partially in section, of a wheel stop shown as Detail 9 of FIG. 7.

FIG. 10 is a top view, partially in section, of the lower support sub-assembly of the hauler, according to a preferred embodiment of the present invention.

FIG. 11 is a side view, partially in section, of the lower support sub-assembly of the hauler of FIG. 10.

FIG. 12 is a side view, partially in section, of the lower support sub-assembly and hitch mating-member of the hauling system, according to another preferred embodiment of the present invention.

FIG. 13 is a side view, partially in section, of the lower support sub-assembly and hitch mating-member of the hauling system, according to yet another preferred embodiment of the present invention.

### DETAILED DESCRIPTION OF THE BEST MODE AND PREFERRED EMBODIMENTS OF THE INVENTION

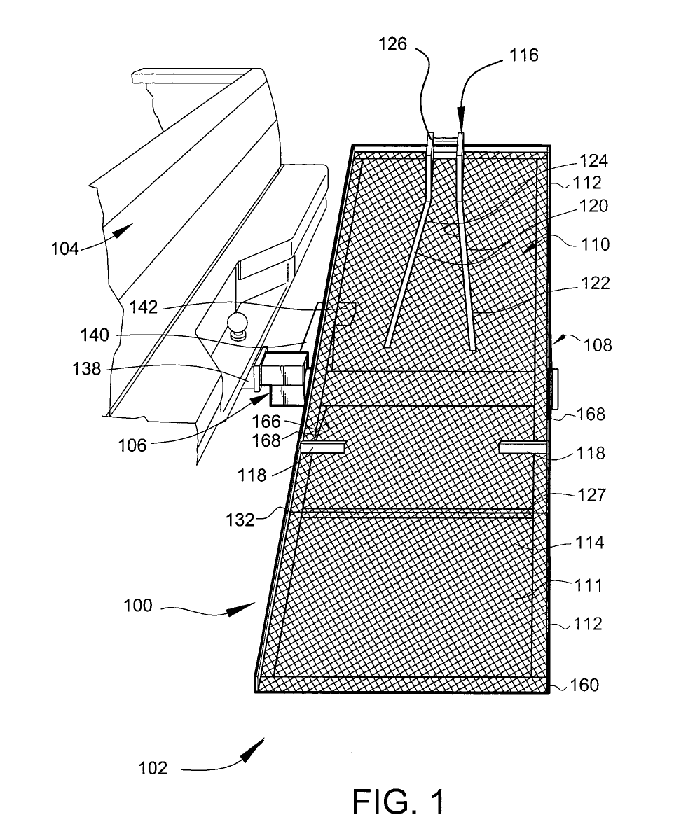

Reference is now made to the drawings. FIG. 1 is a perspective view of a hauler 100 (embodying herein a hauler) of the hauling system 102 attached to a transport vehicle 104 (embodying herein at least one transport vehicle), according to a preferred embodiment of the present invention. FIG. 2 is an illustrated top view of the hauler 100 of FIG. 1.

Preferably, the hauler 100 comprises a lower support sub-assembly 106 and an upper support sub-assembly 108 (this arrangement embodies herein at least one support means for supporting the at least one motorized cart; and embodies herein at least one supporter structured and arranged to support the at least one motorized cart), as shown. Preferably, the upper support sub-assembly 108 rotates around the lower support sub-assembly 106 from a substantially horizontal position to a diagonal ramp position, as shown in FIG. 5 (this arrangement embodies herein tilting means for tilting such at least one support means in at least one first direction such that the at least one motorized cart may be driven onto such at least one support means; and tilting such at least one support means in at least one second direction when the at least one motorized cart is driven substantially onto such at least one support means; and embodies herein at least one tilter, structured and arranged to tilt such at least one supporter in at least one first direction such that the at least one motorized cart may be driven onto such at least one supporter; and structured and arranged to tilt such at least one supporter in at least one second direction when the at least one motorized cart is driven substantially onto such at least one supporter).

Preferably, the upper support sub-assembly 108 comprises a platform 110, preferably rectangular in shape, and substantially planar, as shown. Preferably, the platform 110 comprises an outer frame 112, preferably made from one and one-half inch angle-iron steel, preferably welded together, as shown (the above arrangement embodies herein wherein such supporter comprises a platform and a structural frame). Upon reading the teachings of this specification, those with ordinary skill in the art will now understand that, under appropriate circumstances, considering issues such as economics, durability, environmental concerns, etc., other materials and material dimensions, such as corrosion-resistant materials as well as materials lighter in weight, may suffice. Further, material dimensions, such as round, square, or rectangular may be used for a different appearance, or added strength or cost.

Preferably, the outer frame 112 provides a peripheral support structure for the platform floor 114, preferably a steel mesh 111 (embodying herein wherein such platform is substantially planar and comprises a mesh floor), preferably one-eighth inch expanded metal mesh (such as available from McNichols Company www.mcnichols.com, USA). Upon reading the teachings of this specification, those with ordinary skill in the art will now understand that, under appropriate circumstances, considering issues such as economics, durability, user preference, weight characteristics, etc., other materials, such as aluminum, stainless steel, titanium, etc., may suffice. Functionally, the platform floor 114 must be able to support the intended weight load of the motorized cart and accessories. Preference is for a platform floor 114 that will allow water, dirt, snow and other foreign matter to filter through; however, under appropriate circumstances, a solid floor may be used. Upon reading the teachings of this specification, those with ordinary skill in the art will now understand that, under appropriate circumstances, considering issues such as economics, environment, user preferences, etc., other types of floor arrangements, such as sloped, etc., may suffice.

Preferably, the upper support sub-assembly 108 also comprises a front wheel guide system 116 (embodying herein at least one wheel guiding means, attached to such at least one support means, for guiding at least one wheel of the motorized cart; and embodying herein at least one wheel guider, attached to such at least one supporter, structured and arranged to guide at least one wheel of the motorized cart onto such hauler) and rear wheel blocks 118, as shown. Preferably, the front wheel guide system 116 comprises a wheel-guide-rail 120, preferably comprising a pair of one and one-eighth inch steel L-angle iron rods 122, preferably placed such that each L-angle is outside face 124 to outside face 124 (mirrored), with the perpendicular opposite face facing the platform floor 114 (ground), as shown. Upon reading the teachings of this specification, those with ordinary skill in the art will now understand that, under appropriate circumstances, considering issues such as economics, manufacturing, durability, etc., other materials and material dimensions, may suffice. For example, round rods or other-shaped wheel guide-rail 120 may suffice (if the function of guiding a wheel is maintained). Preferably, the front wheel guide system 116 also comprises a wheel-capture 126, as shown. Preferably, the wheel-capture 126 is dimensioned at a width and height to capture the front wheel 128 of a three-wheeled motorized cart 130 (embodying herein at least one motorized cart), as shown (see FIG. 6). Upon reading the teachings of this specification, those with ordinary skill in the art will now understand that, under appropriate circumstances, considering issues such as economics, manufacturing, durability, etc., other wheel-capture 126 arrangements, for example, square or rounded, may suffice. Additionally, the wheel capture 126 may be used for motorized carts 130 having more than three wheels (e.g., four wheels, etc.).

Preferably, the upper support sub-assembly 108 also comprises at least one additional brace 127 under the platform floor 114, as shown. The steel mesh preferred as the platform floor 114 is available in select sizes that may require seaming of the material. Preferably, a brace 127 is used to seam the mesh together and weld it into place. The seaming is preferably done at either end of the hauler 100, such as shown in FIG. 1 or FIG. 2 at seam 132. Upon reading the teachings of this specification, those with ordinary skill in the art will now understand that, under appropriate circumstances, considering issues such as user preference, economics, weight bearing requirements, durability, etc., other methods of seaming, such as not seaming by utilizing longer material or seaming utilizing multiple seams, may suffice. Furthermore, under appropriate circumstances (such as added weight loads), additional bracing may be used to stiffen the platform floor 114.

Preferably, hauler 100 hauling a single motorized cart, as shown, comprises about the preferred following dimensions. Preferably, Dimension A is about sixty-seven-inches. Preferably, Dimension B is about thirty-five inches. Preferably, Dimension C is about thirty-two inches. Preferably, Dimension D is about twenty-eight-inches. Upon reading the teachings of this specification, those with ordinary skill in the art will now understand that, under appropriate circumstances, considering issues such as user preference, weight balance, economics, manufacturing, etc., other dimensions of the hauler 100 may suffice.

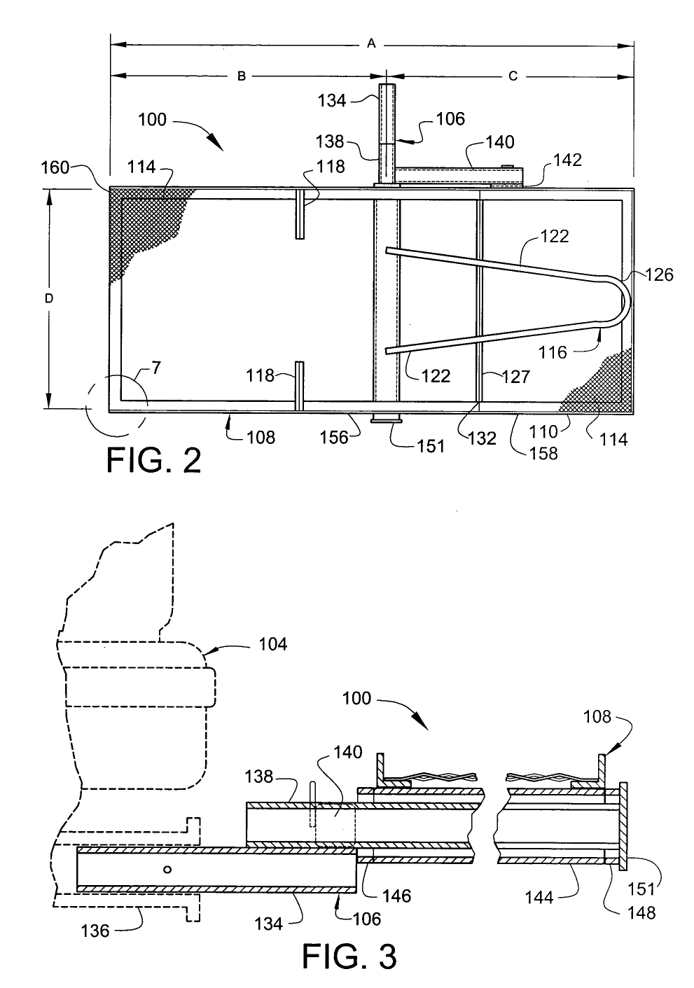

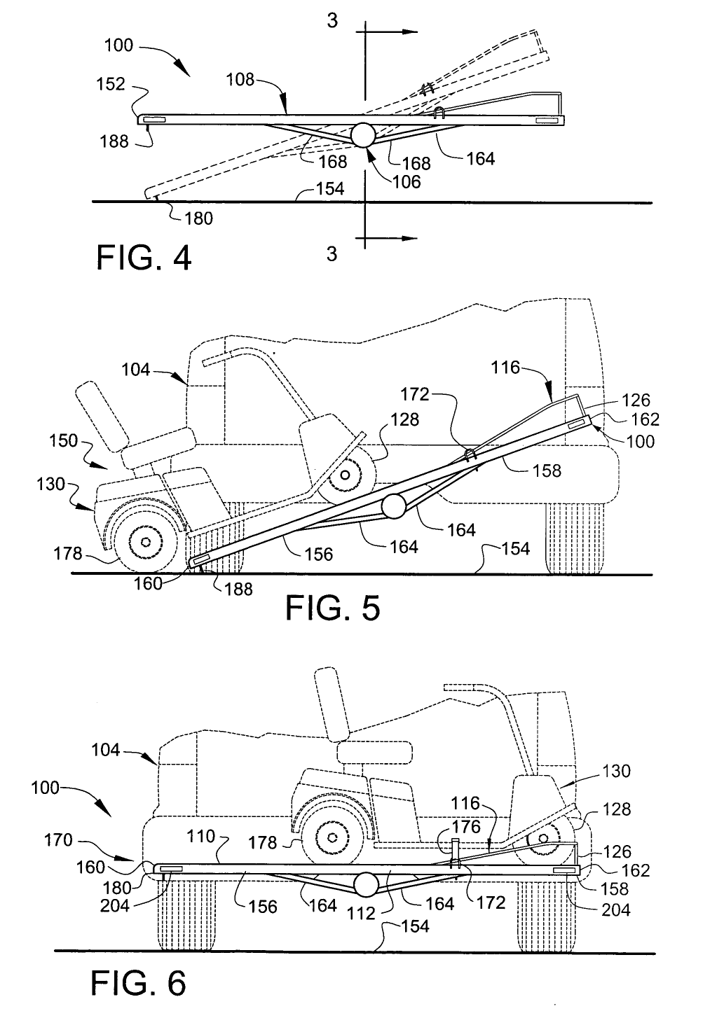

Reference is now made to FIG. 3, in addition to continued reference to the above figures. FIG. 3 illustrates a side view, partially in section, through section 3-3 of FIG. 4, and illustrates the upper support sub-assembly 108, lower support sub-assembly 106 and hitch mating-member 134 (embodying herein at least one hitch mating-member, attachable to such hauler) of the hauling system 102, according to a preferred embodiment of the present invention. Preferably, the transport vehicle 104 comprises a hitch receiver 136 (embodying herein at least one hitch receiver, attachable to the at least one transport vehicle), preferably a trailer-type hitch, designed to support at least the weight of the hauler and transport vehicle, about three hundred pounds (such as a Class III hitch or higher, based upon tongue weight rating, not pulling capacity; most preferably, a trailer-type hitch that will support five hundred pounds or more, such as a Class IV or V hitch). Under appropriate circumstances, other weight support arrangements and hitch receivers 136 may suffice as the hauler 100 and motorized cart 130 (see FIG. 5) preferably weigh about two-hundred-fifty pounds combined, however, such weight may be less or more, depending upon the specific make and model selected by the user. For example, a customized attachment for the hauler 100 and transport vehicle 104 may also be utilized, and as such, a user or manufacturer should consider appropriate safety measures for weight components. Upon reading the teachings of this specification, those with ordinary skill in the art will now understand that, under appropriate circumstances, considering issues such as weight load, legal requirements, transport vehicle limitations, economics, etc., other weight support arrangements may suffice.

Preferably, the hauler 100 comprises a hitch mating-member 134 that preferably mates with the hitch receiver 136, as shown (embodying herein first attachment means for attaching such hauler to the at least one transport vehicle; and, embodying herein at least one first attacher structured and arranged to attach such hauler to the at least one transport vehicle; and, embodying herein wherein such at least one hitch mating-member will mate with such at least one hitch receiver such that when such at least one hitch receiver is attached to the at least one transport vehicle such hauler is substantially supported by the at least one transport vehicle; and, embodying herein wherein the at least one motorized cart is substantially supported by the at least one transport vehicle when such hauler is attached to the at least one transport vehicle and in such substantially horizontal position). Most preferably, the hitch mating-member 134 has a two-inch square interior dimension such that it will accept a two-inch square exterior dimension hitch receiver 136. Preferably, the hitch mating-member 134 and the hitch receiver 136 are steel, preferably painted steel, preferably rated to handle the expected load. Under appropriate circumstances, other materials, such as aluminum, may suffice. Upon reading the teachings of this specification, those with ordinary skill in the art will now understand that, under appropriate circumstances, considering issues such as user preference, weight balance, economics, manufacturing, durability, etc., other dimensions, thickness and materials of the hitch mating-member 134 and the hitch receiver 136 may suffice.

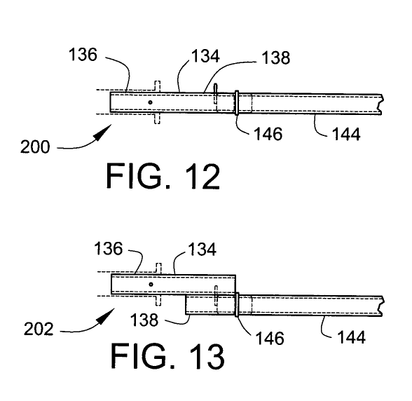

Reference is now made to FIG. 10 and FIG. 11, in addition to the above-referenced figures, providing greater detail of the lower support sub-assembly 106. FIG. 10 is a top view, partially in section, of the lower support sub-assembly 106 of the hauler 100, according to a preferred embodiment of the present invention. FIG. 11 is a side view, partially in section, of the lower support sub-assembly 106 of the hauler 100. Preferably, the lower support sub-assembly 106 further comprises a first bar 138, preferably a two-inch square hollow bar (outside dimensions), preferably steel, preferably painted steel. Under appropriate circumstances, other material arrangements may suffice. Preferably, first bar 138 extends longitudinally from the transport vehicle and transversely below the upper support sub-assembly 108, as shown. Preferably, first bar 138 is the same dimension as the hitch receiver 136 and will telescopically fit into the hitch mating-member 134, as shown. In one preferred embodiment (illustrated in FIG. 12), the first bar 138 and hitch receiver 136 are located along the same bar; however, they may be separate bars, as will be further detailed below.

Preferably, the lower support sub-assembly 106 further comprises a second bar 140, preferably a two-inch-square hollow bar, preferably steel, preferably one-quarter-inch-thick walls, preferably perpendicular to first bar 138, as shown. Preferably, the lower support sub-assembly 106 further comprises a platform blocker 142 (embodying herein at least one first blocking means for blocking such at least one support means in a substantially horizontal position; and, embodying herein at least one first blocker structured and arranged to block such at least one supporter in a substantially horizontal position), preferably parallel and adjacent to the second bar 140, preferably weldably attached to the second bar 140, as shown. Preferably, the second bar 140 is welded in a fixed position to the first bar 138, most preferably in a horizontal alignment parallel to the ground, such that the platform blocker 142 (shown in FIG. 1 and FIG. 2) will stop the platform 110 at about a horizontal position, as shown. Preferably, platform blocker 142 is a two-inch-square bar, preferably steel. Upon reading the teachings of this specification, those with ordinary skill in the art will now understand that, under appropriate circumstances, considering issues such as user preference, weight balance, economics, manufacturing, durability, etc., other dimensions, thickness and materials may suffice. Functionally, the platform blocker 142 should stop the platform 110 at about a horizontal position, as will be further explained below.

Preferably, the upper support sub-assembly 108 comprises a tubular support 144 (embodying herein at least one hollow outer cylinder), preferably about two and one-eighth inches in diameter, that fits over the slightly smaller first bar 138 (embodying herein at least one inner cylinder), as shown. Preferably, a first spacer 146 and a second spacer 148 are welded to the first bar 138 to provide a means for keeping the tubular support 144 positioned and “locked-in” to the lower support sub-assembly 106, as shown. Preferably, an end cap 151 is welded to the second spacer 148 to prevent debris from entering the assembly and provide an aesthetically pleasing end. Preferably, the above-described arrangement, utilizing an inner cylinder within an outer cylinder, provides a structure that allows the upper support sub-assembly 110 to rotate both clockwise and counter-clockwise around the first bar 138, as shown (the above arrangement embodies herein wherein such at least one inner cylinder supports the at least one hollow outer cylinder; wherein such at least one inner cylinder is substantially within such at least one hollow outer cylinder; and wherein such at least one outer cylinder freely rotates around such at least one inner cylinder in both a clockwise and counter-clockwise direction).

Upon reading the teachings of this specification, those with ordinary skill in the art will now understand that, under appropriate circumstances, considering issues such as user preference, economics, durability, ease of use, etc., other methods of keeping the tubular support 144 positioned and “locked-in” to the lower support sub-assembly 106 may suffice.

FIG. 4 is an illustrated front view of the hauler 100 of FIG. 2, according to a preferred embodiment of the present invention. FIG. 5 is an illustrated front view of the hauler 100 of FIG. 2 in a loading position 150, attached to the rear of a transport vehicle 104, according to a preferred embodiment of the present invention.

FIG. 4 illustrates the preferred tilting range of the upper support sub-assembly 108. Preferably, the upper support sub-assembly 108 tilts from about a horizontal position (to the ground 154) to a ramp position such that the end 152 rests on the ground 154, preferably less than about forty-five degrees, most preferably about fifteen-degrees to about thirty-degrees. Upon reading the teachings of this specification, those with ordinary skill in the art will now understand that, under appropriate circumstances, considering issues such as user preference, motorized cart height, weight balance, etc., other tilting ranges may suffice. Further, as stated above, most preferably, the upper support sub-assembly 108 comprises a tubular support 144 that fits over the slightly smaller, preferably square, first bar 138, allowing the upper support sub-assembly 108 to rotate around the first bar 138, as shown. Preferably, the tubular support 144 is attached slightly off-center below the platform 110 such that the portion 156 of the platform 110 on the side to which the hauler 100 will tilt is slightly longer than the portion 158 of the platform 110 on the side to which the motorized cart 130 will be stowed, as shown. Preferably, the portion 156 is adjacent the driver's side 160 of the transport vehicle 104 and is slightly longer and heavier than the portion 158 adjacent the passenger side 162 of the transport vehicle 104.

Preferably, the above-described offset provides a weight and balance differential which, in combination with uninhibited rotation of the upper support sub-assembly 108 around the lower support sub-assembly 106, allows the platform 110 to gravitationally tilt toward the driver's side 160 when the platform 110 is not loaded or tied down, thereby providing a ramp for the motorized cart 130. Upon reading the teachings of this specification, those with ordinary skill in the art will now understand that, under appropriate circumstances, considering issues such as weight load, user requirements (for the handicapped for example), economics, etc., other methods of providing a ramp and also providing a stowable platform may suffice.

Preferably, a user, from a standing position, operates the motorized cart 130 forward onto the platform 110 (when the platform is in the ramp position as shown in FIG. 5, for example). Upon reading the teachings of this specification, those with ordinary skill in the art, will now understand that, under appropriate circumstances, considering issues such as user preferences, road conditions, environmental concerns (i.e., inclement weather), etc., other operating arrangements and methods of loading the motorized cart onto the hauler, such as, for example, while seated or by remote control, may suffice.

Preferably, the motorized cart 130 is pulled forward such that the front wheel guide system 116 guides the front wheel 128 into the wheel-capture 126, as shown (see FIG. 6). Preferably, as the motorized cart 130 is driven onto portion 158, the combined weight of the cart and portion 158 will be greater than the weight of portion 156, and the platform 110 will tilt toward the passenger side 162, until the platform blocker 142 stops it. Preferably, the motorized cart 130 is pulled forward until the front wheel 128 is fully captured by the wheel capture 126, and most preferably, the rear wheels 178 are situated with the rear wheel blocks 118 (best shown in FIG. 1 and FIG. 2) rearward of the rear wheels 178 (this arrangement embodies herein at least one second blocking means for blocking the at least one motorized cart when the at least one motorized cart is supported by such at least one support means and such at least one support means is in such substantially horizontal position; and, embodies herein at least one second blocker structured and arranged to block the at least one motorized cart when the at least one motorized cart is supported by such at least one supporter and such at least one supporter is in such substantially horizontal position). Upon reading the teachings of this specification, those with ordinary skill in the art will now understand that, under appropriate circumstances, considering issues such as motorized cart dimensions, etc., other loading arrangements may suffice.

Reference is now made to FIG. 6, in addition to continued reference to the above figures. FIG. 6 is an illustrated front view of the hauler 100 of FIG. 2 in a transport position 170, attached to the rear of a transport vehicle 104, according to a preferred embodiment of the present invention. Preferably, the platform 110 and motorized cart 130 are in a substantially horizontal position, as the platform rests on the platform blocker 142 (best viewed on FIG. 2). Preferably, the platform comprises a tie-down bracket 172, preferably a looped bracket, preferably steel, preferably attached to the outer frame 112, preferably by welding. Upon reading the teachings of this specification, those with ordinary skill in the art will now understand that, under appropriate circumstances, considering issues such as user preference, economics, ease of use, etc., other styles of tie-down brackets, such as hooks, quick-release clips, etc., may suffice.

Preferably, the lower support sub-assembly 106 also comprises a tie-down bracket 174 (best seen in FIG. 10 and FIG. 11), preferably a loop, preferably steel, preferably attached to the second bar 140. Preferably, the tie-down bracket 172 and the tie-down bracket 174 (embodying herein at least two tie-down connectors) are situated in a line, preferably such that a strap 176 (embodying herein at least one tie-down strap having two ends and being structured and arranged to be tightened, each respective such end being structured and arranged to removably attach to at least one of such at least two tie-down connectors) may be attached to each respective tie-down bracket 172 and 174 and across the motorized cart 130, as shown. Preferably, when the strap 176 is tightly drawn over the motorized cart 130 and between each respective tie-down bracket 172 and 174, the upper support sub-assembly 108 is held tightly to the lower support sub-assembly 106, and the motorized cart 130 will also be securely held to the hauler 100 (this arrangement embodies herein second attachment means for attaching the at least one motorized cart to such hauler; and, embodies herein at least one second attacher structured and arranged to attach the at least one motorized cart to such hauler; and further, embodies herein wherein each respective such end is attached to at least one of such at least two tie-down connectors and tightened over the motorized cart such that the motorized cart is firmly held to such hauler by such at least one tie-down strap and such at least two tie-down connectors). Upon reading the teachings of this specification, those with ordinary skill in the art will now understand that, under appropriate circumstances, considering issues such as user preference, economics, ease of use, etc., other methods of securing the motorized cart 130 securely to the hauler 100 may suffice. For example, the above arrangement utilizing the strap 176 to tightly hold the upper support sub-assembly 108 to the lower support sub-assembly 106 may be used for transporting the hauler when no cart is present. Further, other types of tie-downs may be used, as long as the above-described and preferred function is maintained.

Preferably, unloading of the motorized cart 130 is done in an opposite manner as the loading. Preferably, the strap 176 is untied and removed from between each respective tie-down bracket 172 and 174, such that the motorized cart 130 is no longer secured and may be moved freely and such that the upper support sub-assembly 108 is free to rotate around the lower support sub-assembly 106. Preferably, the motorized cart 130 is then operated such that the motorized cart 130 is reversed and backed up. Preferably, as the motorized cart drives back onto portion 156, the upper support sub-assembly 108 will rotate around the lower support sub-assembly 106, and the platform will gravitationally rotate to a ramp position for unloading of the motorized cart 130, as the weight of the portion 156 and cart will be greater than the weight of portion 158. Preferably, the user can then operate the motorized cart 130 until such time when the user returns, and the user may then easily re-load the motorized cart 130 onto the hauler 100.

Preferably, the upper support sub-assembly 108 further comprises a front support 164 and a rear support 166. Preferably, each respective front support 164 and a rear support 166 comprises a pair of bars 168, preferably one-inch square, eighth-inch-thick steel bars, preferably welded to the platform 110 and to the tubular support 144, as shown. These bars 168 assist in support and stabilizing of the platform 110. Upon reading the teachings of this specification, those with ordinary skill in the art will now understand that, under appropriate circumstances, considering issues such as user preference, ease of use, economic considerations, etc., other support and stabilizing arrangements may suffice.

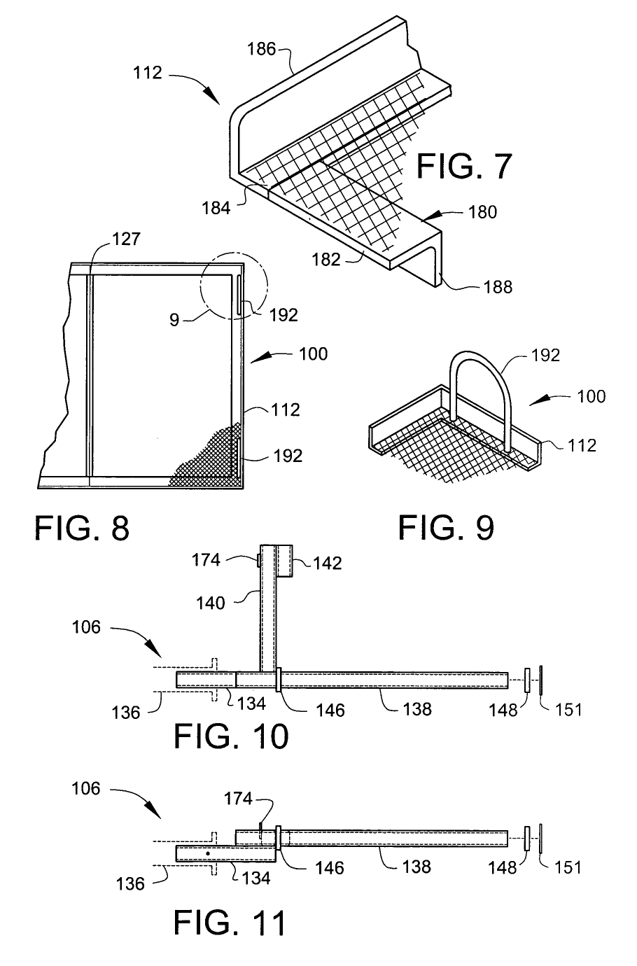

FIG. 7 is a perspective view, partially in section, of Detail 7 of FIG. 2. FIG. 7 illustrates the end-portion 180 of outer frame 112. Preferably, the driver's side 160 of the platform 110 comprises an end-portion 180 in which the one-and-one-half-inch angle-iron steel frame members are “flipped” such that the edge 182 is flush with the inside face 184 of the side member 186, as shown (this arrangement is at each side of the end-portion 180). Preferably, the above arrangement also provides a resting leg 188 that rests on the ground 154 when the platform 110 is tilted in a loading position 150, as shown (the above arrangement embodies herein wherein such platform comprises at least one end which is flush with such mesh floor). Upon reading the teachings of this specification, those with ordinary skill in the art will now understand that, under appropriate circumstances, considering issues such as manufacturing preferences, economic consideration, etc., other resting leg arrangements and framing arrangements, such as use of a separate leg member, etc., may suffice.

FIG. 8 is a top view, partially in section, of the hauler platform 110 illustrating a wheel-stop 192 for a four-wheel cart of the hauling system 102, according to another embodiment of the present invention. FIG. 9 is a perspective view, partially in section, of the wheel-stop 192 of FIG. 8.

Preferably, the hauler 100 may be made to accommodate a four-wheel cart in which there are two front wheels, rather than one front wheel (as is typical on a three-wheel cart), such as shown in FIG. 5. In such instance, the wheel guide-rail 120 may be eliminated to allow for variances in the separation distances between the two front wheels. Preferably, two wheel-stops 192 are then attached to the outer frame 112, as shown. Preferably, the wheel-stops 192 are attached on the passenger side 162 of the hauler 100; however, under appropriate circumstances, other arrangements may suffice. For example, the hauler 100 could be made to tilt on the passenger side 162 rather than the driver's side 160. The driver's side 160 is preferred because handicap parking spaces typically allow more room for loading and offloading on the driver's side 160 of a vehicle. Preferably, the wheel-stops 192 are made from three-eighths-inch steel rod, preferably welded to the outer frame 112, as shown. Upon reading the teachings of this specification, those with ordinary skill in the art will now understand that, under appropriate circumstances, considering issues such as manufacturing preferences, economic consideration, etc., other materials, dimensions and attachments may suffice.

FIG. 12 is a side view, partially in section, of the lower support sub-assembly 106 and hitch mating-member 134 of the hauling system 102, according to another preferred embodiment of the present invention. FIG. 13 is a side view, partially in section, of the lower support sub-assembly 106 and hitch mating-member 134 of the hauling system 102, according to yet another preferred embodiment of the present invention.

As previously described, the first bar 138 and the hitch mating-member 134 may be combined using one bar, as illustrated in embodiment 200 of FIG. 12, or two separate bars may be used, as illustrated in embodiment 202 of FIG. 13. FIG. 13 illustrates the first bar 138 attached under the hitch mating-member 134. FIG. 11 illustrates the first bar attached above the hitch mating-member 134. Preferably, the three embodiments shown provide for a range of height adjustment for the hauling system, depending upon the desired amount of clearance from the hauler 100 to the ground 154. The hauling system 102 is preferably designed for use with multiple styles of transport vehicles. Typically, vehicles with a hitch will have varying heights above the ground, and installation of the hauling system 102 may require some height adjustment for proper functioning of the hauling system 102 (such as providing an adequate ramp angle) and transport vehicle 104 (such as when going over curbs such that the transport vehicle 104 or hauler 100 does not “bottom out”, etc.).

In addition to the above-described features, it is noted that the hauler also comprises light reflectors 204, which are preferably placed along the exterior portion of the outer frame 112 (see FIG. 6); however, different states may have laws regarding such reflector placement, and such placement may easily be modified by those knowledgeable in such art. Upon reading the teachings of this specification, those with ordinary skill in the art will now understand that, under appropriate circumstances, considering issues such as user preference, economics, legal requirements, etc., other methods of providing light reflection or lighting the hauler, such as using trailer lights, etc., may suffice.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A hauling system attachable to at least one transport vehicle, for hauling at least one motorized cart of the type that is drivable, comprising, in combination:
a) a hauler comprising,
i) first attachment means for attaching said hauler to the at least one transport vehicle;
ii) second attachment means for attaching the at least one motorized cart to said hauler;
iii) at least one support means for supporting the at least one motorized cart;
iv) tilting means for
(1) tilting said at least one support means in at least one first direction such that the at least one motorized cart may be driven onto said at least one support means; and
(2) tilting said at least one support means in at least one second direction when the at least one motorized cart is driven substantially onto said at least one support means;
v) at least one first blocking means for blocking said at least one support means in a substantially horizontal position; and
vi) at least one second blocking means for blocking the at least one motorized cart when the at least one motorized cart is supported by said at least one support means and said at least one support means is in said substantially horizontal position;
vii) wherein the at least one motorized cart is substantially supportable by the at least one transport vehicle when said hauler is attached to the at least one transport vehicle and in said substantially horizontal position.

2) The hauling system according to claim 1 further comprising at least one wheel guiding means, attached to said at least one support means, for guiding at least one wheel of the motorized cart onto said hauler.

3) A hauling system attachable to at least one transport vehicle, for hauling at least one motorized cart of the type that is drivable, comprising, in combination:
a) a hauler comprising,
i) at least one first attacher structured and arranged to attach said hauler to the at least one transport vehicle;
ii) at least one second attacher structured and arranged to attach the at least one motorized cart to said hauler;
iii) at least one supporter structured and arranged to support the at least one motorized cart;
iv) at least one tilter,
(1) structured and arranged to tilt said at least one supporter in at least one first direction such that the at least one motorized cart may be driven onto said at least one supporter; and
(2) structured and arranged to tilt said at least one supporter in at least one second direction when the at least one motorized cart is driven substantially onto said at least one supporter;
v) at least one first blocker structured and arranged to block said at least one supporter in a substantially horizontal position; and at least one second blocker structured and arranged to block the at least one motorized cart when the at least one motorized cart is supported by said at least one supporter and said at least one supporter is in said substantially horizontal position;
vi) wherein the at least one motorized cart is substantially supportable by the at least one transport vehicle when said hauler is attached to the at least one transport vehicle and in said substantially horizontal position.

4) The hauling system according to claim 3 further comprising at least one wheel guider, attached to said at least one supporter, structured and arranged to guide at least one wheel of the motorized cart onto said hauler.

5) The hauling system according to claim 3 wherein said at least one first attacher comprises:
a) at least one hitch receiver, attachable to the at least one transport vehicle; and
b) at least one hitch mating-member, attachable to said hauler;
c) wherein said at least one hitch mating-member will mate with said at least one hitch receiver such that when said at least one hitch receiver is attached to the at least one transport vehicle, said hauler is substantially supported by the at least one transport vehicle.

6) The hauling system according to claim 5 wherein said at least one first attacher comprises:
a) at least one hitch receiver, attachable to the at least one transport vehicle; and
b) at least one hitch mating-member, attachable to said hauler;
c) wherein said at least one hitch mating-member will mate with said at least one hitch receiver such that when said at least one hitch receiver is attached to the at least one transport vehicle, said hauler is substantially supported by the at least one transport vehicle.

7) The hauling system according to claim 3 wherein said at least one second attacher comprises:
a) at least two tie-down connectors; and
b) at least one tie-down strap having two ends and being structured and arranged to be tightened, each respective said end being structured and arranged to removably attach to at least one of said at least two tie-down connectors;
c) wherein each respective said end is attached to at least one of said at least two tie-down connectors and tightened over the motorized cart such that the motorized cart is firmly held to said hauler by said at least one tie-down strap and said at least two tie-down connectors.

8) The hauling system according to claim 6 wherein said at least one second attacher comprises:
a) at least two tie-down connectors; and
b) at least one tie-down strap having two ends and being structured and arranged to be tightened, each respective said end being structured and arranged to removably attach to at least one of said at least two tie-down connectors;
c) wherein each respective said end is attached to at least one of said at least two tie-down connectors and tightened over the motorized cart such that the motorized cart is firmly held to said hauler by said at least one tie-down strap and said at least two tie-down connectors.

9) The hauling system according to claim 3 wherein said at least one supporter comprises at least one platform and at least one structural frame.

10) The hauling system according to claim 9 wherein said platform is substantially planar and comprises a mesh floor.

11) The hauling system according to claim 10 wherein said platform comprises at least one end, which is flush with said mesh floor.

12) The hauling system according to claim 11 wherein said at least one supporter comprises at least one platform and at least one structural frame.

13) The hauling system according to claim 3 wherein said at least one tilter comprises:
a) at least one hollow outer cylinder; and
b) at least one inner cylinder;
c) wherein said at least one inner cylinder supports the at least one hollow outer cylinder;
d) wherein said at least one inner cylinder is substantially within said at least one hollow outer cylinder; and
e) wherein said at least one outer cylinder freely rotates around said at least one inner cylinder in both a clockwise and counter-clockwise direction.

14) The hauling system according to claim 12 wherein said at least one tilter comprises:
a) at least one hollow outer cylinder; and
b) at least one inner cylinder;
c) wherein said at least one inner cylinder supports the at least one hollow outer cylinder;
d) wherein said at least one inner cylinder is substantially within said at least one hollow outer cylinder; and
e) wherein said at least one outer cylinder freely rotates around said at least one inner cylinder in both a clockwise and counter-clockwise direction.

15) The hauling system according to claim 14 further comprising at least one wheel guider, attached to said at least one supporter, structured and arranged to guide at least one wheel of the motorized cart onto said hauler.

16) A hauling system, comprising, in combination:
a) at least one transport vehicle;
b) at least one motorized cart;
c) at least one hauler comprising
i) at least one first attacher structured and arranged to attach said hauler to said at least one transport vehicle;
ii) at least one second attacher structured and arranged to attach said at least one motorized cart to said hauler;
iii) at least one supporter structured and arranged to support said at least one motorized cart;
iv) at least one tilter,
(1) structured and arranged to tilt said at least one supporter in at least one first direction such that said at least one motorized cart may be driven onto said at least one supporter; and
(2) structured and arranged to tilt said at least one supporter in at least one second direction when said at least one motorized cart is driven substantially onto said at least one supporter;
v) at least one first blocker structured and arranged to block said at least one supporter in a substantially horizontal position; and
vi) at least one second blocker structured and arranged to block said at least one motorized cart when said at least one motorized cart is supported by said at least one supporter and said at least one supporter is in said substantially horizontal position; and
d) wherein said at least one motorized cart is substantially supported by said at least one transport vehicle when said hauler is attached to said at least one transport vehicle and in said substantially horizontal position.

17) The hauling system according to claim 16 further comprising at least one wheel guider, attached to said at least one supporter, structured and arranged to guide at least one wheel of said motorized cart onto said at least one hauler.

18) The hauling system according to claim 16 wherein said at least one tilter comprises:
a) at least one hollow outer cylinder; and
b) at least one inner cylinder;
c) wherein said at least one inner cylinder supports the at least one hollow outer cylinder;
d) wherein said at least one inner cylinder is substantially within said at least one hollow outer cylinder; and
e) wherein said at least one outer cylinder freely rotates around said at least one inner cylinder in both a clockwise and counter-clockwise direction.

19) The hauling system according to claim 18 wherein said at least one first attacher comprises:
a) at least one hitch receiver, attachable to the at least one transport vehicle; and
b) at least one hitch mating-member, attachable to said hauler;
c) wherein said at least one hitch mating-member will mate with said at least one hitch receiver such that when said at least one hitch receiver is attached to the at least one transport vehicle said hauler is substantially supported by the at least one transport vehicle.

20) The hauling system according to claim 19 wherein said at least one second attacher comprises:
a) at least two tie-down connectors; and
b) at least one tie-down strap having two ends and being structured and arranged to be tightened, each respective said end being structured and arranged to removably attach to at least one of said at least two tie-down connectors;
c) wherein each respective said end is attached to at least one of said at least two tie-down connectors and tightened over the motorized cart such that the motorized cart is firmly held to said hauler by said at least one tie-down strap and said at least two tie-down connectors.
